(19) United States
(12) Patent Application Publication
(10) Pub. No.: US 2023/0408743 A1
(43) Pub. Date: Dec. 21, 2023

(54) LIQUID CRYSTAL OPTICAL ELEMENT

(71) Applicants: Japan Display Inc., Tokyo (JP); OSAKA UNIVERSITY, Osaka (JP)

(72) Inventors: Ayaka HIGUCHI, Tokyo (JP); Koichi IGETA, Tokyo (JP); Shinichiro OKA, Tokyo (JP); Yasushi TOMIOKA, Tokyo (JP); Hiroyuki YOSHIDA, Suita-shi (JP)

(73) Assignees: Japan Display Inc., Tokyo (JP); OSAKA UNIVERSITY, Osaka (JP)

(21) Appl. No.: 18/331,389

(22) Filed: Jun. 8, 2023

(30) Foreign Application Priority Data
Jun. 8, 2022 (JP) 2022-092897

(51) Int. Cl. G02B 5/30

(52) U.S. Cl. CPC G02B 5/3016

(57) ABSTRACT

According to one embodiment, a liquid crystal optical element includes a first liquid crystal layer including a first cholesteric liquid crystal and a second liquid crystal layer including a second cholesteric liquid crystal, a helical pitch of each of the first cholesteric liquid crystal and the second cholesteric liquid crystal changing continuously. The first cholesteric liquid crystal including a first portion having a first helical pitch and a second portion having a second helical pitch different from the first helical pitch. The second cholesteric liquid crystal including a third portion having a third helical pitch and a fourth portion having a fourth helical pitch different from the third helical pitch.

### CROSS-REFERENCE TO RELATED APPLICATIONS

This application is based upon and claims the benefit of priority from Japanese Patent Application No. 2022-092897, filed Jun. 8, 2022, the entire contents of which are incorporated herein by reference.

### FIELD

Embodiments described herein relate generally to a liquid crystal optical element.

### BACKGROUND

For example, liquid crystal polarization gratings for which liquid crystal materials are used have been proposed. In such liquid crystal polarization gratings, in order to achieve desired reflective performance, it is necessary to adjust various parameters such as the grating cycle T, the refractive anisotropy Δn of a liquid crystal layer (difference between the refractive index ne for extraordinary light and the refractive index no for ordinary light of the liquid crystal layer), and the thickness d of the liquid crystal layer.

### BRIEF DESCRIPTION OF THE DRAWINGS

FIG. 1 is a cross-sectional view schematically showing a liquid crystal optical element 100.

FIG. 2 is a diagram for explaining an example of first cholesteric liquid crystals 31 included in a first liquid crystal layer 3.

FIG. 3 is a plan view schematically showing the liquid crystal optical element 100.

FIG. 4 is a diagram for explaining Example 1.

FIG. 5 is a diagram for explaining Example 2.

FIG. 6 is a diagram for explaining a manufacturing method of the liquid crystal optical element 100.

FIG. 7 is a diagram for explaining Example 3.

FIG. 8 is a diagram for explaining Example 4.

FIG. 9 is a diagram for explaining Example 5.

FIG. 10 is a diagram for explaining the manufacturing method of the liquid crystal optical element 100.

FIG. 11 is a diagram for explaining Example 6.

### DETAILED DESCRIPTION

In general, according to one embodiment, a liquid crystal optical element comprises a transparent substrate, a first liquid crystal layer overlapping the transparent substrate and comprising a first cholesteric liquid crystal, and a second liquid crystal layer overlapping the first liquid crystal layer and comprising a second cholesteric liquid crystal. A helical pitch of each of the first cholesteric liquid crystal and the second cholesteric liquid crystal changes continuously. The first cholesteric liquid crystal comprises a first portion close to the transparent substrate, and having a first helical pitch, and a second portion located between the first portion and the second liquid crystal layer, and having a second helical pitch different from the first helical pitch. The second cholesteric liquid crystal comprises a third portion close to the first liquid crystal layer, and having a third helical pitch, and a fourth portion located further away from the first liquid crystal layer than the third portion, and having a fourth helical pitch different from the third helical pitch.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

Note that, in order to make the descriptions more easily understandable, some of the drawings illustrate an X axis, a Y axis and a Z axis orthogonal to each other. A direction along the Z axis is referred to as a Z direction or a first direction A1, a direction along the Y axis is referred to as a Y direction or a second direction A2 and a direction along the X axis is referred to as an X direction or a third direction A3. A plane defined by the X axis and the Y axis is referred to as an X-Y plane, a plane defined by the X axis and the Z axis is referred to as an X-Z plane, and a plane defined by the Y axis and the Z axis is referred to as a Y-Z plane.

(Basic Configuration)

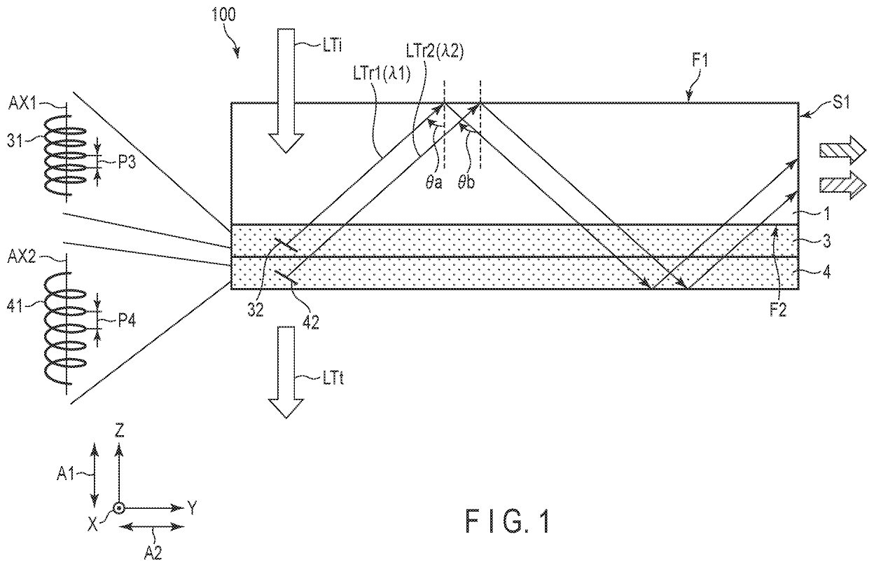

FIG. 1 is a cross-sectional view schematically showing a liquid crystal optical element 100.

The liquid crystal optical element 100 comprises a transparent substrate 1, a first liquid crystal layer 3, and a second liquid crystal layer 4. The liquid crystal optical element 100 may comprise an alignment film interposed between the transparent substrate 1 and the first liquid crystal layer 3, which is not shown in FIG. 1. In addition, the liquid crystal optical element 100 may comprise an adhesive layer between the first liquid crystal layer 3 and the second liquid crystal layer 4.

The transparent substrate 1 is composed of, for example, a transparent glass plate or a transparent synthetic resin plate. The transparent substrate 1 may be composed of, for example, a transparent synthetic resin plate having flexibility. The transparent substrate 1 can assume an arbitrary shape. For example, the transparent substrate 1 may be curved.

In the present specification, “light” includes visible light and invisible light. For example, the wavelength of the lower limit of the visible light range is greater than or equal to 360 nm but less than or equal to 400 nm, and the wavelength of the upper limit of the visible light range is greater than or equal to 760 nm but less than or equal to 830 nm. Visible light includes a first component (blue component) of a first wavelength band (for example, 400 nm to 500 nm), a second component (green component) of a second wavelength band (for example, 500 nm to 600 nm), and a third component (red component) of a third wavelength band (for example, 600 nm to 700 nm). Invisible light includes ultraviolet rays of a wavelength band shorter than the first wavelength band and infrared rays of a wavelength band longer than the third wavelength band.

In the present specification, to be “transparent” should preferably be to be colorless and transparent. Note that to be “transparent” may be to be translucent or to be colored and transparent. The transparent substrate 1 is formed into the shape of a flat plate along the X-Y plane, and comprises a main surface (outer surface) F1, a main surface (inner surface) F2, and a side surface S1. The main surface F1 and the main surface F2 are surfaces substantially parallel to the X-Y plane and are opposed to each other in the first direction A1. The side surface S1 is a surface extending in the first direction A1. In the example shown in FIG. 1, the side surface S1 is a surface substantially parallel to the X-Z plane, but the side surface S1 includes a surface substantially parallel to the Y-Z plane.

The first liquid crystal layer 3 overlaps the transparent substrate 1 in the first direction A1.

The second liquid crystal layer 4 overlaps the first liquid crystal layer 3 in the first direction A1.

The first liquid crystal layer 3 comprises a first cholesteric liquid crystal 31 as schematically shown in an enlarged manner. The first cholesteric liquid crystal 31 has a helical axis AX1 substantially parallel to the first direction A1 and has a helical pitch P3 in the first direction A1.

The second liquid crystal layer 4 comprises a second cholesteric liquid crystal 41 as schematically shown in an enlarged manner. In the example shown in the figure, the first cholesteric liquid crystal 31 and the second cholesteric liquid crystal 41 both turn in the same direction, but they may turn in the directions opposite to each other. The second cholesteric liquid crystal 41 has a helical axis AX2 substantially parallel to the first direction A1 and has a helical pitch P4 in the first direction A1. The helical axis AX1 is parallel to the helical axis AX2. The helical pitches P3 and P4 each indicate one cycle of the helix (layer thickness along the helical axis necessary for liquid crystal molecules to rotate 360 degrees).

The first liquid crystal layer 3 and the second liquid crystal layer 4 reflect circularly polarized light of a selective reflection band determined according to the helical pitch and the refractive anisotropy, of light LTi incident through the transparent substrate 1. In the present specification, “reflection” in each of the liquid crystal layers involves diffraction inside the liquid crystal layers.

In the first liquid crystal layer 3, the first cholesteric liquid crystal 31 comprises a reflective surface 32 which reflects circularly polarized light corresponding to the turning direction of the first cholesteric liquid crystal 31, of the selective reflection band.

In the second liquid crystal layer 4, the second cholesteric liquid crystal 41 comprises a reflective surface 42 which reflects circularly polarized light corresponding to the turning direction of the second cholesteric liquid crystal 41, of the selective reflection band. In the present specification, circularly polarized light may be precise circularly polarized light or may be circularly polarized light approximate to elliptically polarized light.

The optical action of the liquid crystal optical element 100 shown in FIG. 1 will be described next.

The example shown in the figure illustrates a case where the first liquid crystal layer 3 and the second liquid crystal layer 4 reflect at least part of light LTi incident from the transparent substrate 1 side toward the transparent substrate 1. The first liquid crystal layer 3 and the second liquid crystal layer 4 also reflect part of light incident from the second liquid crystal layer 4 side, but the explanation thereof is omitted here.

Light LTi incident on the liquid crystal optical element 100 includes, for example, visible light, ultraviolet rays, and infrared rays.

In the example shown in FIG. 1, to facilitate understanding, light LTi is incident substantially perpendicularly to the transparent substrate 1. The angle of incidence of light LTi to the transparent substrate 1 is not particularly limited.

Light LTi enters the inside of the transparent substrate 1 from the main surface F1, is emitted from the main surface F2, and is incident on the first liquid crystal layer 3. Then, the first liquid crystal layer 3 reflects part of light LTi at the reflective surface 32 toward the transparent substrate 1 and transmits the other light. Reflected light LTr1 is circularly polarized light of a wavelength λ1.

Light LTt transmitted through the first liquid crystal layer 3 is incident on the second liquid crystal layer 4. Then, the second liquid crystal layer 4 reflects part of light LTt at the reflective surface 42 toward the transparent substrate 1 and transmits the other light. Reflected light LTr2 is circularly polarized light of a wavelength λ2. Light LTt transmitted through the second liquid crystal layer 4 includes, for example, visible light V.

The angle Ga of entry at which light LTr1 reflected by the first liquid crystal layer 3 enters the transparent substrate 1 and the angle Gb of entry at which light LTr2 reflected by the second liquid crystal layer 4 enters the transparent substrate 1 are set to satisfy the conditions for optical waveguide in the transparent substrate 1. The angles Ga and Gb of entry here correspond to angles greater than or equal to the critical angle θc which causes total reflection at the interface between the transparent substrate 1 and the air. The angles Ga and Gb of entry represent angles to a perpendicular line orthogonal to the main surface F1 of the transparent substrate 1.

If the transparent substrate 1, the first liquid crystal layer 3, and the second liquid crystal layer 4 have equivalent refractive indices, the stacked layer body of these can be a single optical waveguide body. In this case, light LTr1 and light LTr2 are guided toward the side surface S1 while being repeatedly reflected at the interface between the transparent substrate 1 and the air and the interface between the second liquid crystal layer 4 and the air.

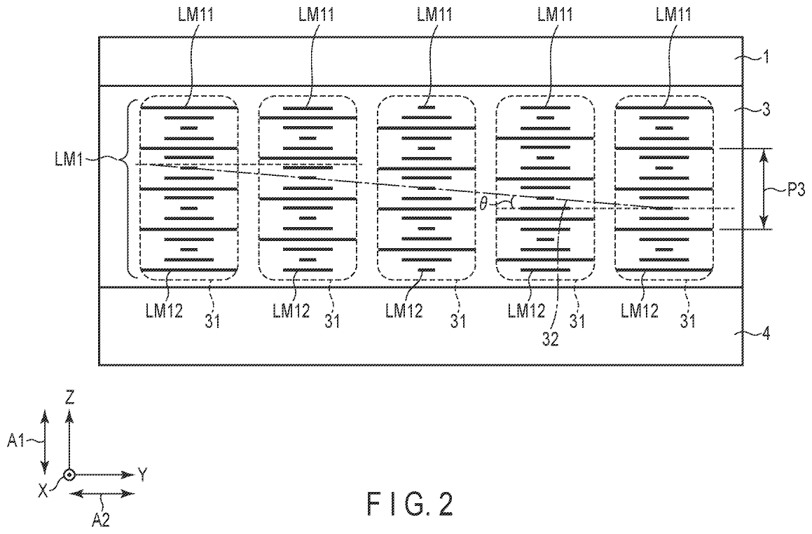

FIG. 2 is a diagram for explaining an example of first cholesteric liquid crystals 31 included in the first liquid crystal layer 3.

In FIG. 2, the first liquid crystal layer 3 is shown in a state of being enlarged in the first direction A1. In addition, for the sake of simplification, one liquid crystal molecule LM1 of the liquid crystal molecules located in the same plane parallel to the X-Y plane is shown in the figure as liquid crystal molecules LM1 constituting the first cholesteric liquid crystals 31. The alignment direction of the liquid crystal molecule LM1 shown in the figure corresponds to the average alignment direction of the liquid crystal molecules located in the same plane.

Each first cholesteric liquid crystal 31 enclosed by a broken line is constituted of liquid crystal molecules LM1 helically stacked in the first direction A1 while being turned. The liquid crystal molecules LM1 comprise a liquid crystal molecule LM11 on one end side of the first cholesteric liquid crystals 31 and a liquid crystal molecule LM12 on the other end side of the first cholesteric liquid crystals 31. The liquid crystal molecule LM11 is close to the transparent substrate 1. The liquid crystal molecule LM12 is close to the second liquid crystal layer 4.

In the first liquid crystal layer 3 of the example shown in FIG. 2, the alignment directions of the first cholesteric liquid crystals 31 adjacent to each other in the second direction A2 are different from each other. In addition, the spatial phases of the first cholesteric liquid crystals 31 adjacent to each other in the second direction A2 are different from each other.

The alignment directions of the liquid crystal molecules LM11 adjacent to each other in the second direction A2 are different from each other. The alignment directions of the liquid crystal molecules LM11 change continuously in the second direction A2.

The alignment directions of the liquid crystal molecules LM12 adjacent to each other in the second direction A2 are also different from each other. The alignment directions of the liquid crystal molecules LM12 also change continuously in the second direction A2.

The reflective surface 32 of the first liquid crystal layer 3 indicated by an alternate long and short dashed line in the figure is inclined with respect to the X-Y plane. The angle θ formed by the reflective surface 32 and the X-Y plane is an acute angle. The reflective surface 32 corresponds to a surface along which the alignment directions of the liquid crystal molecules LM1 are identical or a surface along which the spatial phases are the same (equiphase wave surface).

The above-described first liquid crystal layer 3 is cured in a state where the alignment directions of the liquid crystal molecules LM1 are fixed. That is, the alignment directions of the liquid crystal molecules LM1 are not controlled in accordance with an electric field. For this reason, the liquid crystal optical element 100 does not comprise an electrode for forming an electric field in the first liquid crystal layer 3.

In general, in a liquid crystal layer comprising a cholesteric liquid crystal, a selective reflection band Δλ for perpendicularly incident light is expressed as equation (1) below, based on the helical pitch P of the cholesteric liquid crystal and the refractive anisotropy Δn of the liquid crystal layer (difference between the refractive index ne for extraordinary light and the refractive index no for ordinary light).

Δλ=Δn*P (1)

The specific wavelength range of the selective reflection band Δλ is greater than or equal to no*P but less than or equal to ne*P.

The center wavelength λm of the selective reflection band λλ is expressed as equation (2) below, based on the helical pitch of the cholesteric liquid crystal and the average refractive index nav (=(ne+no)/2) of the liquid crystal layer.

λm=nav*P (2)

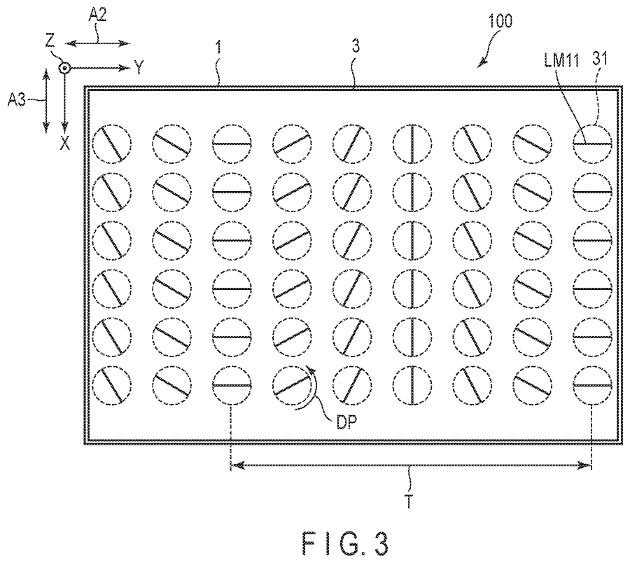

FIG. 3 is a plan view schematically showing the liquid crystal optical element 100.

FIG. 3 shows an example of the spatial phases of the first cholesteric liquid crystals 31. The spatial phases here are shown as the alignment directions of the liquid crystal molecules LM11 located close to the transparent substrate 1 of the liquid crystal molecules LM1 included in the first cholesteric liquid crystals 31.

The alignment directions of the liquid crystal molecules LM11 differ from each other between each first cholesteric liquid crystal 31 arranged in the second direction A2. That is, the spatial phases of the first cholesteric liquid crystals 31 are different in the second direction A2.

In contrast, the alignment directions of the liquid crystal molecules LM11 are substantially identical between each first cholesteric liquid crystal 31 arranged in the third direction A3. That is, the spatial phases of the first cholesteric liquid crystals 31 are substantially same in the third direction A3.

In particular, in the first cholesteric liquid crystals 31 arranged in the second direction A2, the respective alignment directions of the liquid crystal molecules LM11 differ by equal angles. That is, the alignment directions of the liquid crystal molecules LM11 arranged in the second direction A2 change linearly. Accordingly, the spatial phases of the first cholesteric liquid crystals 31 arranged in the second direction A2 change linearly in the second direction A2. As a result, as in the first liquid crystal layer 3 shown in FIG. 2, the reflective surface 32 inclined with respect to the X-Y plane is formed. The phrase “linearly change” here means, for example, that the amount of change of the alignment directions of the liquid crystal molecules LM11 is represented by a linear function. The alignment directions of the liquid crystal molecules LM11 here correspond to the major-axis directions of the liquid crystal molecules LM11 in the X-Y plane.

Here, in one plane, the interval between two liquid crystal molecules LM11 between which the alignment directions of the liquid crystal molecules LM11 change by 180 degrees in the second direction A2 is defined as a cycle T. In FIG. 3, DP denotes the turning direction of the liquid crystal molecules LM11. The angle θ of inclination of the reflective surface 32 shown in FIG. 2 is set as appropriate by the cycle T and the helical pitch P.

Although not described in detail here, in the second liquid crystal layer 4, too, the reflective surface 42 inclined with respect to the X-Y plane is formed by the second cholesteric liquid crystals 41 which are formed in the same manner as the first cholesteric liquid crystals 31.

### Example 1

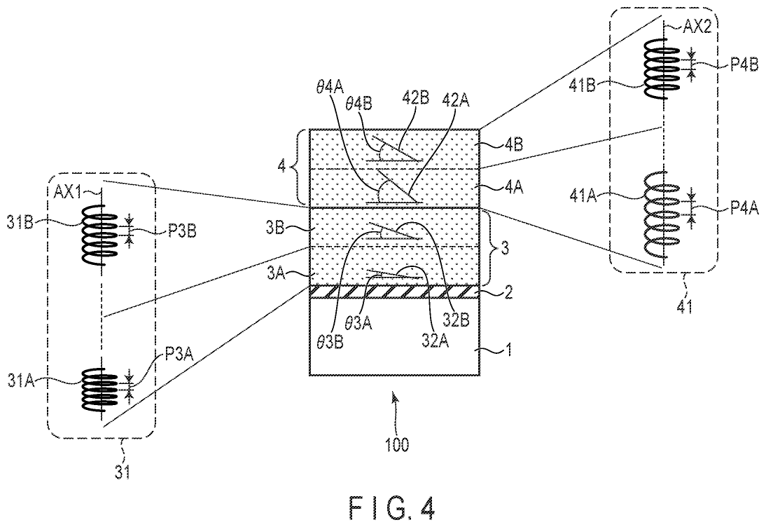

FIG. 4 is a diagram for explaining Example 1.

The liquid crystal optical element 100 comprises an alignment film 2 between the transparent substrate 1 and the first liquid crystal layer 3. The second liquid crystal layer 4 has close contact with the first liquid crystal layer 3.

The first liquid crystal layer 3 comprises a region 3A and a region 3B. The region 3A is a region close to the transparent substrate 1 and is located between the transparent substrate 1 and the region 3B.

The second liquid crystal layer 4 comprises a region 4A and a region 4B. The region 4A is a region close to the first liquid crystal layer 3 and is located between the first liquid crystal layer 3 and the region 4B.

In the first liquid crystal layer 3, the first cholesteric liquid crystal 31 is formed over the region 3A and the region 3B. The helical pitch of the first cholesteric liquid crystal 31 changes continuously, and becomes greater as it becomes further away from the transparent substrate 1. The first cholesteric liquid crystal 31 comprises a portion 31A located in the region 3A and a portion 31B located in the region 3B. In other words, the portion 31A is located between the transparent substrate 1 and the portion 31B, and the portion 31B is located between the portion 31A and the second liquid crystal layer 4. The portion 31A has a helical pitch P3A and the portion 31B has a helical pitch P3B. The helical pitch P3A and the helical pitch P3B are different from each other. In Example 1, the helical pitch P3A is smaller than the helical pitch P3B (P3A<P3B).

In the region 3A, the portion 31A of the first cholesteric liquid crystal 31 forms a reflective surface 32A. In the region 3B, the portion 31B of the first cholesteric liquid crystal 31 forms a reflective surface 32B. The angle θ3A of inclination of the reflective surface 32A is smaller than the angle θ3B of inclination of the reflective surface 32B (θ3A<θ3B).

In the second liquid crystal layer 4, the second cholesteric liquid crystal 41 is formed over the region 4A and the region 4B. The helical pitch of the second cholesteric liquid crystal 41 changes continuously, and becomes smaller as it becomes further away from the transparent substrate 1. The second cholesteric liquid crystal 41 comprises a portion 41A located in the region 4A and a portion 41B located in the region 4B. In other words, the portion 41A is located between the first liquid crystal layer 3 and the portion 41B, and the portion 41B is located further away from the first liquid crystal layer 3 than the portion 41A. The portion 41A has a helical pitch P4A and the portion 41B has a helical pitch P4B. The helical pitch P4A and the helical pitch P4B are different from each other. In Example 1, the helical pitch P4A is greater than the helical pitch P4B (P4A>P4B).

In the region 4A, the portion 41A of the second cholesteric liquid crystal 41 forms a reflective surface 42A. In the region 4B, the portion 41B of the second cholesteric liquid crystal 41 forms a reflective surface 42B. The angle θ4A of inclination of the reflective surface 42A is greater than the angle θ4B of inclination of the reflective surface 42B (θ4A>θ4B).

A manufacturing method of the liquid crystal optical element 100 will be described next.

First, the alignment film 2 is formed on the transparent substrate 1. Then, the alignment treatment of the alignment film 2 is performed.

Then, a first liquid crystal material (solution including a monomeric material for forming the first cholesteric liquid crystal 31) is applied to the top of the alignment film 2. Then, the first liquid crystal material is baked for three minutes at a temperature close to a nematic-isotropic transition temperature (NI point). Through the baking, the liquid crystal molecules included in the first liquid crystal material are aligned in a predetermined direction in accordance with the direction of the alignment treatment of the alignment film 2. Then, the first liquid crystal material is irradiated with ultraviolet rays, and the first liquid crystal material is cured. In this way, the first liquid crystal layer 3 comprising the first cholesteric liquid crystal 31 is formed. At this time, the helical pitch P3 of the first cholesteric liquid crystal 31 is substantially uniform.

Next, a second liquid crystal material (solution including a monomeric material for forming the second cholesteric liquid crystal 41) is applied to the top of the first liquid crystal layer 3. Then, the second liquid crystal material is baked for fifteen minutes at a temperature approximately 10° C. lower than the NI point. Through the baking, the liquid crystal molecules included in the second liquid crystal material are aligned in a predetermined direction in accordance with the alignment direction of liquid crystal molecules close to the surface of the first liquid crystal layer 3. Then, the second liquid crystal material is irradiated with ultraviolet rays, and the second liquid crystal material is cured. In this way, the second liquid crystal layer 4 comprising the second cholesteric liquid crystal 41 is formed.

At this time, the second liquid crystal material penetrates the first liquid crystal layer 3, which is formed earlier. In addition, the region 3B swells more than the region 3A. The first liquid crystal layer 3 is dried in this state, and consequently, of the first cholesteric liquid crystal 31, the helical pitch P3B of the portion 31B located in the region 3B enlarges more than the helical pitch P3A of the portion 31A located in the region 3A.

On the other hand, in the second liquid crystal layer 4, the drying of the region 4B on the surface side is promoted, thereby forming a state where the region 4A swells more than the region 4B. The second liquid crystal layer 4 is cured in this state, and consequently, of the second cholesteric liquid crystal 41, the helical pitch P4A of the portion 41A located in the region 4A enlarges more than the helical pitch P4B of the portion 41B located in the region 4B.

The liquid crystal optical element 100 shown in FIG. 4 is thereby manufactured.

For example, in order to set the center wavelength λm of the selective reflection band in the first liquid crystal layer 3 at 530 nm, a material having an average refractive index nav of 1.65 is applied as the first liquid crystal material, and an adjustment is made with a chiral agent to set the helical pitch P3 at 320 nm. The helical pitch P3A in the portion 31A is approximately 340 nm, and the helical pitch P3B in the portion 31B is approximately 380 nm.

In addition, in order to set the center wavelength λm of the selective reflection band in the second liquid crystal layer 4 at 920 nm, a material having an average refractive index nav of 1.63 is applied as the second liquid crystal material, and an adjustment is made with a chiral agent to set the helical pitch P4 at 530 nm. The helical pitch P4A in the portion 41A is approximately 560 nm, and the helical pitch P4B in the portion 41B is approximately 440 nm.

In this manner, the first liquid crystal layer 3 comprises the first cholesteric liquid crystal 31, in which the helical pitch P3 changes continuously, and the second liquid crystal layer 4 comprises the second cholesteric liquid crystal 41, in which the helical pitch P4 changes continuously. The reflection band in the liquid crystal optical element 100 thereby can be enlarged.

### Example 2

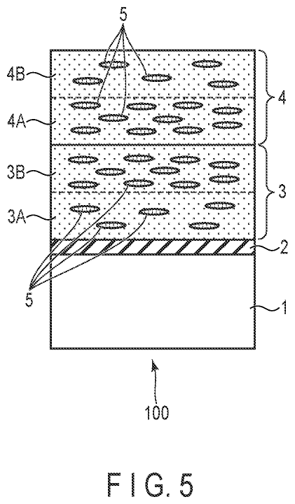

FIG. 5 is a diagram for explaining Example 2.

The liquid crystal optical element 100 comprises the alignment film 2 between the transparent substrate 1 and the first liquid crystal layer 3. The second liquid crystal layer 4 is attached to the first liquid crystal layer 3 by adhesive which is omitted in the figure.

Example 2 is different from Example 1 in that each of the first liquid crystal layer 3 and the second liquid crystal layer 4 includes additive 5 exhibiting liquid crystalline properties.

Although omitted in FIG. 5, as in Example 1 shown in FIG. 4, the region 3A comprises the reflective surface 32A at the angle θ3A of inclination, the region 3B comprises the reflective surface 32B at the angle θ3B of inclination, the region 4A comprises the reflective surface 42A at the angle θ4A of inclination, and the region 4B comprises the reflective surface 42B at the angle θ4B of inclination.

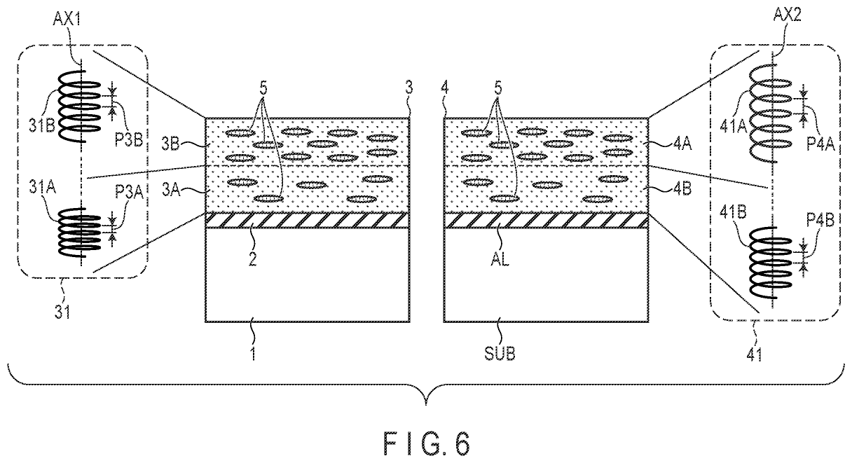

The manufacturing method of the liquid crystal optical element 100 will be described next with reference to FIG. 6.

First, the alignment film 2 is formed on the transparent substrate 1. Then, the alignment treatment of the alignment film 2 is performed.

Then, the first liquid crystal material (solution including a monomeric material for forming the first cholesteric liquid crystal 31) is applied to the top of the alignment film 2. Then, the first liquid crystal material is baked for three minutes at a temperature close to the NI point. Through the baking, the liquid crystal molecules included in the first liquid crystal material are aligned in a predetermined direction in accordance with the direction of the alignment treatment of the alignment film 2. Then, the first liquid crystal material is irradiated with ultraviolet rays, and the first liquid crystal material is cured. In this way, the first liquid crystal layer 3 comprising the first cholesteric liquid crystal 31 is formed. At this time, the helical pitch P3 of the first cholesteric liquid crystal 31 is substantially uniform.

On the other hand, an alignment film AL is formed on a support substrate SUB, and the alignment treatment of the alignment film AL is performed. Then, the second liquid crystal material (solution including a monomeric material for forming the second cholesteric liquid crystal 41) is applied to the top of the alignment film AL. Then, the second liquid crystal material is baked for three minutes at a temperature close to the NI point. Through the baking, the liquid crystal molecules included in the second liquid crystal material are aligned in a predetermined direction in accordance with the direction of the alignment treatment of the alignment film AL. Then, the second liquid crystal material is irradiated with ultraviolet rays, and the second liquid crystal material is cured. In this way, the second liquid crystal layer 4 comprising the second cholesteric liquid crystal 41 is formed. At this time, the helical pitch P4 of the second cholesteric liquid crystal 41 is substantially uniform.

Then, a liquid crystal solution including the additive 5 is applied to each of the first liquid crystal layer 3 and the second liquid crystal layer 4. The liquid crystal solution is a solution prepared by dissolving the additive 5 in a solvent. As the solvent, organic solvents such as hexane, cyclohexane, cyclohexanone, heptane, toluene, anisole, and propylene glycol monomethyl ether acetate (PGMEA) can be applied. As the additive 5, a liquid crystal material different in concentration from each of the first liquid crystal material and the second liquid crystal material such as 4-Cyano-4″-pentyl-p-terphenyl (another name: 5CT) or 4′-pentyl-4-biphenylcarbonitrile (another name: 5CP) can be applied.

Then, each of the first liquid crystal layer 3 and the second liquid crystal layer 4 is baked for three minutes at a temperature 10° C. lower than the NI point. Then, each of the first liquid crystal layer 3 and the second liquid crystal layer 4 is irradiated with ultraviolet rays, and each of the first liquid crystal layer 3 and the second liquid crystal layer 4 is cured. In this way, as for the first liquid crystal layer 3, the region 3B is formed on the surface side and the region 3A is formed between the transparent substrate 1 and the region 3B, and as for the second liquid crystal layer 4, the region 4A is formed on the surface side and the region 4B is formed between the support substrate SUB and the region 4A. The helical pitch of the first cholesteric liquid crystal 31 formed over the region 3A and the region 3B becomes greater as it becomes further away from the transparent substrate 1. In addition, the helical pitch of the second cholesteric liquid crystal 41 formed over the region 4A and the region 4B becomes greater as it becomes further away from the support substrate SUB.

That is, of the first cholesteric liquid crystal 31, the helical pitch P3B of the portion 31B located in the region 3B is greater than the helical pitch P3A of the portion 31A located in the region 3A. In addition, of the second cholesteric liquid crystal 41, the helical pitch P4A of the portion 41A located in the region 4A is greater than the helical pitch P4B of the portion 41B located in the region 4B.

Then, the second liquid crystal layer 4 is peeled from the support substrate SUB, the front and back sides of the second liquid crystal layer 4 are reversed, and the region 4A is attached to the region 3B. The liquid crystal optical element 100 shown in FIG. 5 is thereby manufactured.

In Example 2 described above, too, as in Example 1, the reflection band in the liquid crystal optical element 100 can be enlarged.

In Example 1 and Example 2 described above, the portion 31A corresponds to a first portion, and the helical pitch P3A corresponds to a first helical pitch. The portion 31B corresponds to a second portion, and the helical pitch P3B corresponds to a second helical pitch. The portion 41A corresponds to a third portion, and the helical pitch P4A corresponds to a third helical pitch. The portion 41B corresponds to a fourth portion, and the helical pitch P4B corresponds to a fourth helical pitch.

The region 3A corresponds to a first region, and the reflective surface 32A corresponds to a first reflective surface. The region 3B corresponds to a second region, and the reflective surface 32B corresponds to a second reflective surface. The region 4A corresponds to a third region, and the reflective surface 42A corresponds to a third reflective surface. The region 4B corresponds to a fourth region, and the reflective surface 42B corresponds to a fourth reflective surface.

### Example 3

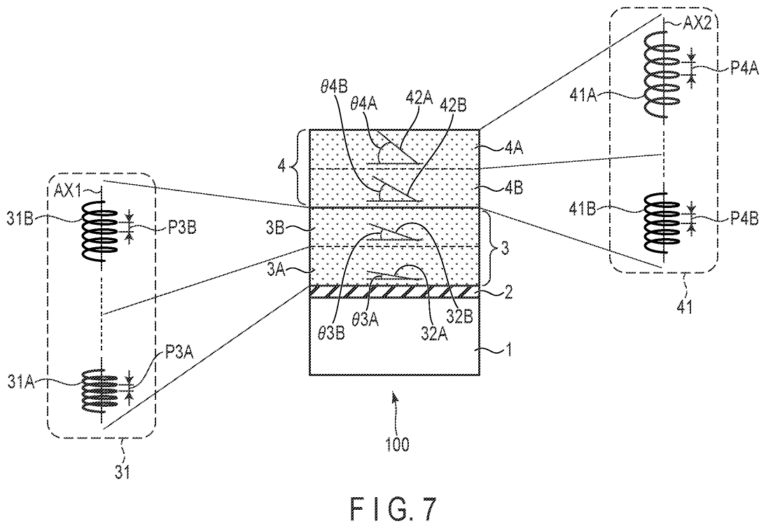

FIG. 7 is a diagram for explaining Example 3.

The liquid crystal optical element 100 comprises the alignment film 2 between the transparent substrate 1 and the first liquid crystal layer 3. The second liquid crystal layer 4 is attached to the first liquid crystal layer 3 by adhesive which is omitted in the figure.

Example 3 is different from Example 2 in that the region 4B of the second liquid crystal layer 4 is attached to the region 3B of the first liquid crystal layer 3. Each of the first liquid crystal layer 3 and the second liquid crystal layer 4 includes the additive exhibiting liquid crystalline properties, which is omitted in FIG. 7, as in Example 2 shown in FIG. 5.

In the first liquid crystal layer 3, the helical pitch of the first cholesteric liquid crystal 31 formed over the region 3A and the region 3B changes continuously, and becomes greater as it becomes further away from the transparent substrate 1. That is, the helical pitch P3A of the portion 31A located in the region 3A is smaller than the helical pitch P3B of the portion 31B located in the region 3B (P3A<P3B).

The angle θ3A of inclination of the reflective surface 32A located in the region 3A is smaller than the angle θ3B of inclination of the reflective surface 32B located in the region 3B (θ3A<θ3B).

In the second liquid crystal layer 4, the helical pitch of the second cholesteric liquid crystal 41 formed over the region 4A and the region 4B changes continuously, and becomes greater as it becomes further away from the transparent substrate 1. That is, the helical pitch P4B of the portion 41B located in the region 4B is smaller than the helical pitch P4A of the portion 41A located in the region 4A (P4A>P4B).

The angle θ4B of inclination of the reflective surface 42B located in the region 4B is smaller than the angle θ4A of inclination of the reflective surface 42A located in the region 4A (θ4A>θ4B).

The manufacturing method of the liquid crystal optical element 100 of Example 3 is the same as the manufacturing method of the liquid crystal optical element 100 of Example 2, which has been described with reference to FIG. 6. The following is a brief explanation of the manufacturing method.

First, after the alignment film 2 is formed on the transparent substrate 1, the alignment treatment of the alignment film 2 is performed, and the first liquid crystal material is applied to the top of the alignment film 2. Then, the first liquid crystal material is baked, the first liquid crystal material is irradiated with ultraviolet rays, and the first liquid crystal layer 3 is formed.

Then, the liquid crystal solution including the additive 5 is applied to the first liquid crystal layer 3. Then, the first liquid crystal material is baked, and the first liquid crystal material is irradiated with ultraviolet rays. In this way, the first cholesteric liquid crystal 31, in which the helical pitch becomes greater as it becomes further away from the transparent substrate 1, is formed.

On the other hand, after the alignment film AL is formed on the support substrate SUB, the alignment treatment of the alignment film AL is performed, and the second liquid crystal material is applied to the top of the alignment film AL. Then, the second liquid crystal material is baked, the second liquid crystal material is irradiated with ultraviolet rays, and the second liquid crystal layer 4 is formed.

Then, the liquid crystal solution including the additive 5 is applied to the second liquid crystal layer 4. Then, the second liquid crystal material is baked, and the second liquid crystal material is irradiated with ultraviolet rays. In this way, the second cholesteric liquid crystal 41, in which the helical pitch which becomes greater as it becomes further away from the support substrate SUB, is formed.

Then, the second liquid crystal layer 4 is peeled from the support substrate SUB, and the region 4B of the second liquid crystal layer 4 is attached to the region 3B of the first liquid crystal layer 3. The liquid crystal optical element 100 shown in FIG. 7 is thereby manufactured.

In Example 3 described above, too, as in Example 1, the reflection band in the liquid crystal optical element 100 can be enlarged.

In Example 3 described above, the portion 31A corresponds to a first portion, and the helical pitch P3A corresponds to a first helical pitch. The portion 31B corresponds to a second portion, and the helical pitch P3B corresponds to a second helical pitch. The portion 41B corresponds to a third portion, and the helical pitch P4B corresponds to a third helical pitch. The portion 41A corresponds to a fourth portion, and the helical pitch P4A corresponds to a fourth helical pitch.

The region 3A corresponds to a first region, and the reflective surface 32A corresponds to a first reflective surface. The region 3B corresponds to a second region, and the reflective surface 32B corresponds to a second reflective surface. The region 4B corresponds to a third region, and the reflective surface 42B corresponds to a third reflective surface. The region 4A corresponds to a fourth region, and the reflective surface 42A corresponds to a fourth reflective surface.

### Example 4

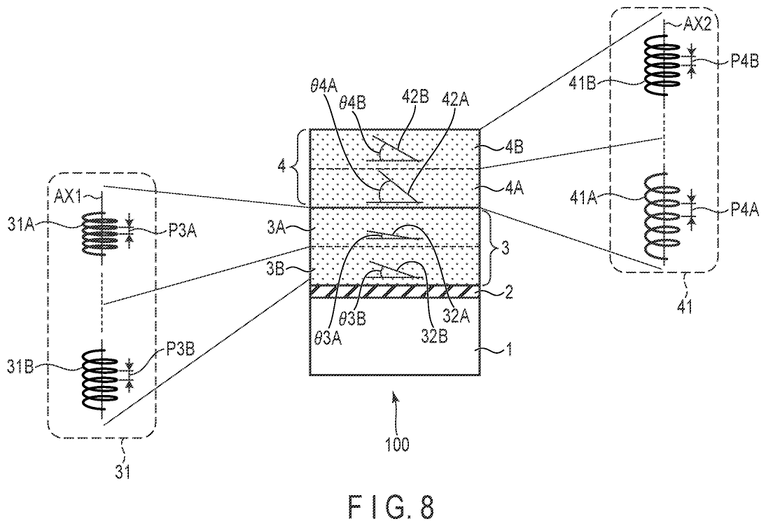

FIG. 8 is a diagram for explaining Example 4.

The liquid crystal optical element 100 comprises the alignment film 2 between the transparent substrate 1 and the first liquid crystal layer 3. The second liquid crystal layer 4 has close contact with the first liquid crystal layer 3.

The first liquid crystal layer 3 comprises the region 3A and the region 3B. The region 3B is a region close to the transparent substrate 1 and is located between the transparent substrate 1 and the region 3A.

The second liquid crystal layer 4 comprises the region 4A and the region 4B. The region 4A is a region close to the first liquid crystal layer 3 and is located between the first liquid crystal layer 3 and the region 4B.

In the first liquid crystal layer 3, the helical pitch of the first cholesteric liquid crystal 31 formed over the region 3A and the region 3B changes continuously, and becomes smaller as it becomes further away from the transparent substrate 1. That is, the helical pitch P3B of the portion 31B located in the region 3B is greater than the helical pitch P3A of the portion 31A located in the region 3A (P3A<P3B). The angle θ3B of inclination of the reflective surface 32B located in the region 3B is greater than the angle θ3A of inclination of the reflective surface 32A located in the region 3A (θ3A<θ3B).

In the second liquid crystal layer 4, the helical pitch of the second cholesteric liquid crystal 41 formed over the region 4A and the region 4B changes continuously, and becomes smaller as it becomes further away from the transparent substrate 1. That is, the helical pitch P4A of the portion 41A located in the region 4A is greater than the helical pitch P4B of the portion 41B located in the region 4B (P4A>P4B).

The angle θ4A of inclination of the reflective surface 42A located in the region 4A is greater than the angle θ4B of inclination of the reflective surface 42B located in the region 4B (θ4A>θ4B).

The manufacturing method of the liquid crystal optical element 100 will be described next.

First, the alignment film 2 is formed on the transparent substrate 1. Then, the alignment treatment of the alignment film 2 is performed.

Then, the first liquid crystal material (solution including a monomeric material for forming the first cholesteric liquid crystal 31) is applied to the top of the alignment film 2. Then, the first liquid crystal material is baked for three minutes at a temperature close to a nematic-isotropic transition temperature (NI point). Then, the first liquid crystal material is irradiated with ultraviolet rays, and the first liquid crystal material is cured. In this way, the first liquid crystal layer 3 comprising the first cholesteric liquid crystal 31 is formed. At this time, the helical pitch P3 of the first cholesteric liquid crystal 31 is substantially uniform.

Then, the second liquid crystal material (solution including a monomeric material for forming the second cholesteric liquid crystal 41) is applied to the top of the first liquid crystal layer 3. Then, the second liquid crystal material is baked for fifteen minutes at a temperature lower than the NI point. At this time, the baking temperature is still lower than in Example 1 and is, for example, a temperature approximately 20° C. lower than the NI point. Then, the second liquid crystal material is irradiated with ultraviolet rays, and the second liquid crystal material is cured. In this way, the second liquid crystal layer 4 comprising the second cholesteric liquid crystal 41 is formed.

At this time, the second liquid crystal material penetrates the first liquid crystal layer 3, which is formed earlier. Since the baking is performed at a temperature still lower than in Example 1, the penetration of the region 3B, which is close to the transparent substrate 1, of the first liquid crystal layer 3 by the second liquid crystal material is promoted. In addition, the region 3B swells more than the region 3A. The first liquid crystal layer 3 is dried in this state, and consequently, of the first cholesteric liquid crystal 31, the helical pitch P3B of the portion 31B located in the region 3B enlarges more than the helical pitch P3A of the portion 31A located in the region 3A.

On the other hand, in the second liquid crystal layer 4, the drying of the region 4B on the surface side is promoted, thereby forming a state where the region 4A swells more than the region 4B. The second liquid crystal layer 4 is cured in this state, and consequently, of the second cholesteric liquid crystal 41, the helical pitch P4A of the portion 41A located in the region 4A enlarges more than the helical pitch P4B of the portion 41B located in the region 4B.

The liquid crystal optical element 100 shown in FIG. 8 is thereby manufactured.

In Example 4 described above, too, as in Example 1, the reflection band in the liquid crystal optical element 100 can be enlarged.

### Example 5

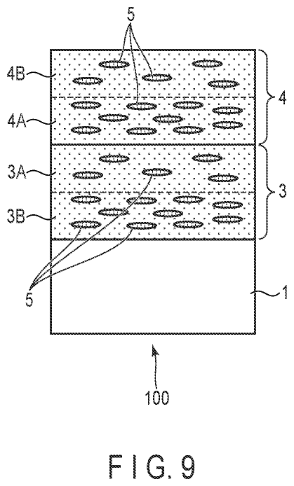

FIG. 9 is a diagram for explaining Example 5.

In the liquid crystal optical element 100, the first liquid crystal layer 3 is attached to the transparent substrate 1 by adhesive which is omitted in the figure. The second liquid crystal layer 4 is attached to the first liquid crystal layer 3 by adhesive which is omitted in the figure.

Example 5 is different from Example 4 in that each of the first liquid crystal layer 3 and the second liquid crystal layer 4 includes the additive 5 exhibiting liquid crystalline properties.

Although omitted in FIG. 9, as in Example 4 shown in FIG. 8, the region 3A comprises the reflective surface 32A at the angle θ3A of inclination, the region 3B comprises the reflective surface 32B at the angle θ3B of inclination, the region 4A comprises the reflective surface 42A at the angle θ4A of inclination, and the region 4B comprises the reflective surface 42B at the angle θ4B of inclination.

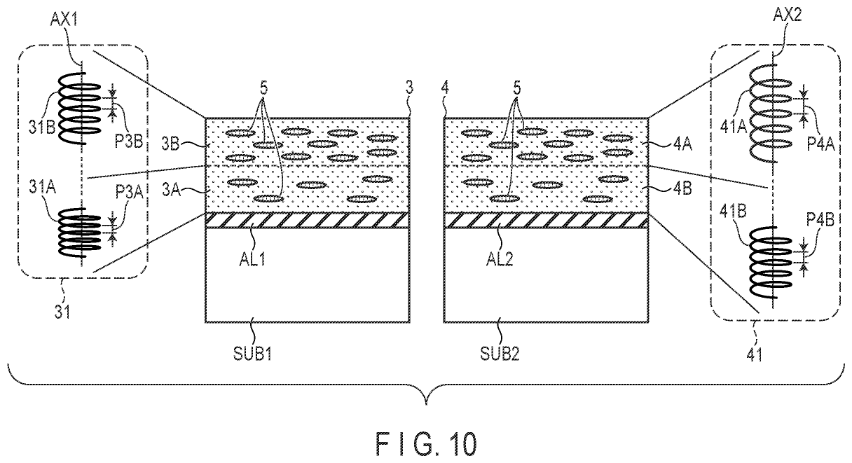

The manufacturing method of the liquid crystal optical element 100 will be described next with reference to FIG. 10.

First, an alignment film AL1 is formed on a support substrate SUB1. Then, the alignment treatment of the alignment film AL1 is performed.

Then, the first liquid crystal material (solution including a monomeric material for forming the first cholesteric liquid crystal 31) is applied to the top of the alignment film AL1. Then, the first liquid crystal material is baked for three minutes at a temperature close to the NI point. Then, the first liquid crystal material is irradiated with ultraviolet rays, and the first liquid crystal material is cured. In this way, the first liquid crystal layer 3 comprising the first cholesteric liquid crystal 31 is formed. At this time, the helical pitch P3 of the first cholesteric liquid crystal 31 is substantially uniform.

On the other hand, an alignment film AL2 is formed on a support substrate SUB2, and the alignment treatment of the alignment film AL2 is performed. Then, the second liquid crystal material (solution including a monomeric material for forming the second cholesteric liquid crystal 41) is applied to the top of the alignment film AL2. Then, the second liquid crystal material is baked for three minutes at a temperature close to the NI point. Then, the second liquid crystal material is irradiated with ultraviolet rays, and the second liquid crystal material is cured. In this way, the second liquid crystal layer 4 comprising the second cholesteric liquid crystal 41 is formed. At this time, the helical pitch P4 of the second cholesteric liquid crystal 41 is substantially uniform.

Then, the liquid crystal solution including the additive 5 is applied to each of the first liquid crystal layer 3 and the second liquid crystal layer 4. The details of the liquid crystal solution are as described in Example 1.

Then, each of the first liquid crystal layer 3 and the second liquid crystal layer 4 is baked for three minutes at a temperature 10° C. lower than the NI point. Then, each of the first liquid crystal layer 3 and the second liquid crystal layer 4 is irradiated with ultraviolet rays, and each of the first liquid crystal layer 3 and the second liquid crystal layer 4 is cured. In this way, as for the first liquid crystal layer 3, the region 3B is formed on the surface side and the region 3A is formed between the support substrate SUB1 and the region 3B, and as for the second liquid crystal layer 4, the region 4A is formed on the surface side and the region 4B is formed between the support substrate SUB2 and the region 4A. The helical pitch of the first cholesteric liquid crystal 31 formed over the region 3A and the region 3B becomes greater as it becomes further away from the support substrate SUB1. In addition, the helical pitch of the second cholesteric liquid crystal 41 formed over the region 4A and the region 4B becomes greater as it becomes further away from the support substrate SUB2.

Then, the first liquid crystal layer 3 is peeled from the support substrate SUB1, the front and back sides of the first liquid crystal layer 3 are reversed, and the region 3B is attached to the transparent substrate 1. Then, the second liquid crystal layer 4 is peeled from the support substrate SUB2, the front and back sides of the second liquid crystal layer 4 are reversed, and the region 4A is attached to the region 3A. The liquid crystal optical element 100 shown in FIG. 9 is thereby manufactured.

In Example 5 described above, too, as in Example 1, the reflection band in the liquid crystal optical element 100 can be enlarged.

In Example 4 and Example 5 described above, the portion 31B corresponds to a first portion, and the helical pitch P3B corresponds to a first helical pitch. The portion 31A corresponds to a second portion, and the helical pitch P3A corresponds to a second helical pitch. The portion 41A corresponds to a third portion, and the helical pitch P4A corresponds to a third helical pitch. The portion 41B corresponds to a fourth portion, and the helical pitch P4B corresponds to a fourth helical pitch.

The region 3B corresponds to a first region, and the reflective surface 32B corresponds to a first reflective surface. The region 3A corresponds to a second region, and the reflective surface 32A corresponds to a second reflective surface. The region 4A corresponds to a third region, and the reflective surface 42A corresponds to a third reflective surface. The region 4B corresponds to a fourth region, and the reflective surface 42B corresponds to a fourth reflective surface.

### Example 6

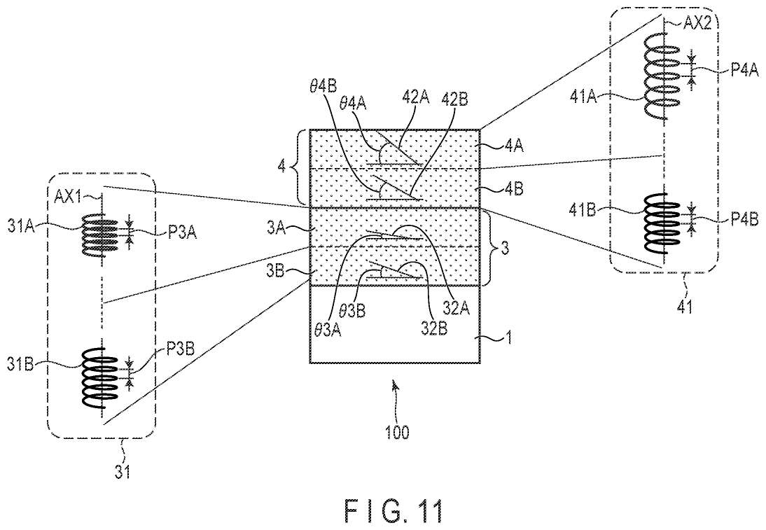

FIG. 11 is a diagram for explaining Example 6.

In the liquid crystal optical element 100, the first liquid crystal layer 3 is attached to the transparent substrate 1 by adhesive which is omitted in the figure. The second liquid crystal layer 4 is attached to the first liquid crystal layer 3 by adhesive which is omitted in the figure.

Example 6 is different from Example 5 in that the region 4B of the second liquid crystal layer 4 is attached to the region 3A of the first liquid crystal layer 3. Each of the first liquid crystal layer 3 and the second liquid crystal layer 4 includes the additive 5 exhibiting liquid crystalline properties, which is omitted in FIG. 11, as in Example 5 shown in FIG. 9.

In the first liquid crystal layer 3, the helical pitch of the first cholesteric liquid crystal 31 formed over the region 3A and the region 3B changes continuously, and becomes smaller as it becomes further away from the transparent substrate 1. That is, the helical pitch P3B of the portion 31B located in the region 3B is greater than the helical pitch P3A of the portion 31A located in the region 3A (P3A<P3B).

The angle θ3B of inclination of the reflective surface 32B located in the region 3B is greater than the angle θ3A of inclination of the reflective surface 32A located in the region 3A (θ3A<θ3B).

In the second liquid crystal layer 4, the helical pitch of the second cholesteric liquid crystal 41 formed over the region 4A and the region 4B changes continuously, and becomes greater as it becomes further away from the transparent substrate 1. That is, the helical pitch P4B of the portion 41B located in the region 4B is smaller than the helical pitch P4A of the portion 41A located in the region 4A (P4A>P4B).

The angle θ4B of inclination of the reflective surface 42B located in the region 4B is smaller than the angle θ4A of inclination of the reflective surface 42A located in the region 4A (θ4A>θ4B).

The manufacturing method of the liquid crystal optical element 100 of Example 6 is the same as the manufacturing method of the liquid crystal optical element 100 of Example 5, which has been described with reference to FIG. 10. The following is a brief explanation of the manufacturing method.

First, after the alignment film AL1 is formed on the support substrate SUB1, the alignment treatment of the alignment film AL1 is performed, and the first liquid crystal material is applied to the top of the alignment film AL′. Then, the first liquid crystal material is baked, the first liquid crystal material is irradiated with ultraviolet rays, and the first liquid crystal layer 3 is formed.

Then, the liquid crystal solution including the additive 5 is applied to the first liquid crystal layer 3. Then, the first liquid crystal material is baked, and the first liquid crystal material is irradiated with ultraviolet rays. In this way, the first cholesteric liquid crystal 31, in which the helical pitch becomes greater as it becomes further away from the support substrate SUB1, is formed.

On the other hand, after the alignment film AL2 is formed on the support substrate SUB2, the alignment treatment of the alignment film AL2 is performed, and the second liquid crystal material is applied to the top of the alignment film AL2. Then, the second liquid crystal material is baked, the second liquid crystal material is irradiated with ultraviolet rays, and the second liquid crystal layer 4 is formed.

Then, the liquid crystal solution including the additive 5 is applied to the second liquid crystal layer 4. Then, the second liquid crystal material is baked, and the second liquid crystal material is irradiated with ultraviolet rays. In this way, the second cholesteric liquid crystal 41, in which the helical pitch becomes greater as it becomes further away from the support substrate SUB2, is formed.

Then, the first liquid crystal layer 3 is peeled from the support substrate SUB1, the front and back sides of the first liquid crystal layer 3 are reversed, and the region 3B is attached to the transparent substrate 1. Then, the second liquid crystal layer 4 is peeled from the support substrate SUB2, and the region 4B of the second liquid crystal layer 4 is attached to the region 3A of the first liquid crystal layer 3. The liquid crystal optical element 100 shown in FIG. 11 is thereby manufactured.

In Example 6 described above, too, as in Example 1, the reflection band in the liquid crystal optical element 100 can be enlarged.

In Example 6 described above, the portion 31B corresponds to a first portion, and the helical pitch P3B corresponds to a first helical pitch. The portion 31A corresponds to a second portion, and the helical pitch P3A corresponds to a second helical pitch. The portion 41B corresponds to a third portion, and the helical pitch P4B corresponds to a third helical pitch. The portion 41A corresponds to a fourth portion, and the helical pitch P4A corresponds to a fourth helical pitch.

The region 3B corresponds to a first region, and the reflective surface 32B corresponds to a first reflective surface. The region 3A corresponds to a second region, and the reflective surface 32A corresponds to a second reflective surface. The region 4B corresponds to a third region, and the reflective surface 42B corresponds to a third reflective surface. The region 4A corresponds to a fourth region, and the reflective surface 42A corresponds to a fourth reflective surface.

Example 1 to Example 6 described above illustrate cases where the first liquid crystal layer 3 is located between the transparent substrate 1 and the second liquid crystal layer 4; however, the second liquid crystal layer 4 may be located between the transparent substrate 1 and the first liquid crystal layer 3.

As described above, according to the present embodiment, a liquid crystal optical element which can enlarge a reflection band and which can achieve desired reflective performance can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid crystal optical element comprising:
a transparent substrate;
a first liquid crystal layer overlapping the transparent substrate and comprising a first cholesteric liquid crystal; and
a second liquid crystal layer overlapping the first liquid crystal layer and comprising a second cholesteric liquid crystal,
a helical pitch of each of the first cholesteric liquid crystal and the second cholesteric liquid crystal changing continuously,
the first cholesteric liquid crystal comprising:
a first portion close to the transparent substrate, and having a first helical pitch; and
a second portion located between the first portion and the second liquid crystal layer, and having a second helical pitch different from the first helical pitch,
the second cholesteric liquid crystal comprising:
a third portion close to the first liquid crystal layer, and having a third helical pitch; and
a fourth portion located further away from the first liquid crystal layer than the third portion, and having a fourth helical pitch different from the third helical pitch.

2. The liquid crystal optical element of claim 1, wherein the first helical pitch is smaller than the second helical pitch, and
the third helical pitch is greater than the fourth helical pitch.

3. The liquid crystal optical element of claim 2, wherein an angle of inclination of a first reflective surface formed by the first portion is smaller than an angle of inclination of a second reflective surface formed by the second portion, and
an angle of inclination of a third reflective surface formed by the third portion is greater than an angle of inclination of a fourth reflective surface formed by the fourth portion.

4. The liquid crystal optical element of claim 3, further comprising an alignment film interposed between the transparent substrate and the first liquid crystal layer.

5. The liquid crystal optical element of claim 4, wherein each of the first liquid crystal layer and the second liquid crystal layer includes an additive exhibiting a liquid crystalline property.

6. The liquid crystal optical element of claim 1, wherein the first helical pitch is smaller than the second helical pitch, and
the third helical pitch is smaller than the fourth helical pitch.

7. The liquid crystal optical element of claim 6, wherein an angle of inclination of a first reflective surface formed by the first portion is smaller than an angle of inclination of a second reflective surface formed by the second portion, and
an angle of inclination of a third reflective surface formed by the third portion is smaller than an angle of inclination of a fourth reflective surface formed by the fourth portion.

8. The liquid crystal optical element of claim 7, further comprising an alignment film interposed between the transparent substrate and the first liquid crystal layer.

9. The liquid crystal optical element of claim 8, wherein each of the first liquid crystal layer and the second liquid crystal layer includes an additive exhibiting a liquid crystalline property.

10. The liquid crystal optical element of claim 1, wherein the first helical pitch is greater than the second helical pitch, and
the third helical pitch is greater than the fourth helical pitch.

11. The liquid crystal optical element of claim 10, wherein an angle of inclination of a first reflective surface formed by the first portion is greater than an angle of inclination of a second reflective surface formed by the second portion, and
an angle of inclination of a third reflective surface formed by the third portion is greater than an angle of inclination of a fourth reflective surface formed by the fourth portion.

12. The liquid crystal optical element of claim 11, further comprising an alignment film interposed between the transparent substrate and the first liquid crystal layer.

13. The liquid crystal optical element of claim 11, wherein each of the first liquid crystal layer and the second liquid crystal layer includes an additive exhibiting a liquid crystalline property.

14. The liquid crystal optical element of claim 1, wherein the first helical pitch is greater than the second helical pitch, and
the third helical pitch is smaller than the fourth helical pitch.

15. The liquid crystal optical element of claim 14, wherein an angle of inclination of a first reflective surface formed by the first portion is greater than an angle of inclination of a second reflective surface formed by the second portion, and
an angle of inclination of a third reflective surface formed by the third portion is smaller than an angle of inclination of a fourth reflective surface formed by the fourth portion.

16. The liquid crystal optical element of claim 15, wherein each of the first liquid crystal layer and the second liquid crystal layer includes an additive exhibiting a liquid crystalline property.
